(19) United States
(12) Patent Application Publication
(10) Pub. No.: US 2025/0379912 A1
(43) Pub. Date: Dec. 11, 2025

(54) SESSION BINDING CONTROL IN WIRELESS COMMUNICATION NETWORKS

(71) Applicant: T-MOBILE INNOVATIONS LLC, Overland Park, KS (US)

(72) Inventor: Suryaprakash Reddy Voodem, Bothell, WA (US)

(21) Appl. No.: 18/737,157

(22) Filed: Jun. 7, 2024

(51) Int. Cl. H04L 67/141

(52) U.S. Cl. CPC H04L 67/141

(57) ABSTRACT

Various embodiments include a wireless communication network that comprises network circuitry. The network circuitry executes a policy controller, session controller, and binding data store. The policy controller detects a session binding request failure to a binding data store and indicates a retry timer to the session controller that manages a session for a wireless user device. The policy controller provides network policies to the session controller for the session of the wireless user device. The policy controller receives a policy update request from the session controller in response to expiration of the retry timer. The policy controller transfers a session binding request to the binding data store. The binding data store receives the session binding request and stores a session binding that associates the policy controller and the wireless user device.

### TECHNICAL FIELD

Various embodiments of the present technology relate to data management, and more specifically, to controlling session binding retry in response to session binding failure.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices. Exemplary network functions include Access and Mobility Management Function (AMF), Session Management Function (SMF), User Plane Function (UPF), Policy Control Function (PCF), and Binding Support Function (BSF).

A wireless user device registers over a RAN with an AMF in the core network to receive wireless services. Registration entails authentication of the device and authorization of the device for service on the network. Once registered, the device transfers a session request to the AMF over the RAN to begin a data session. The AMF directs the SMF in the network core to establish the session for the device. The SMF interacts with the PCF to retrieve network policies that govern the device's level of service during the session. Exemplary network policies include Quality-of-Service (QoS) values, data routing rules, and the like. The SMF controls the UPF to serve the user device the data session over the RAN based on the retrieved policies. The PCF stores session data that characterizes the network policies for the device. The PCF stores a session binding that associates the PCF with the user device on the BSF. The BSF maintains a catalog of bindings between the PCFs in the network and the user devices receiving service on the network. The BSF may expose the session bindings to network functions, network operators, and/or third parties for a variety of services (e.g., network topology serving).

Wireless communication networks and large and complex. This complexity results in errors on the PCF and/or BSF that inhibit the BSF from creating the session binding between the PCF and the user device. When the BSF fails to create a session binding, the PCF transfers one or more retry requests to the BSF to reattempt session binding creation. If the error condition persists, the PCF forgoes session binding and provides network policies to the SMF. The SMF then enforces the retrieved policies to control the session for the user device without the creation of the session binding. As such, these session bindings are not stored on the BSF which reduces the overall accuracy of the data stored by the BSF. The reduced accuracy limits the usefulness of the BSF to other network functions, network operators, and/or third parties. Unfortunately, in some instances, wireless communication networks may not effectively or efficiently create session bindings between user devices and PCFs on the BSF.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network data management. Some embodiments comprise a method. The method comprises detecting, by a policy controller of a wireless communication network, a session binding request failure to a binding data store, wherein the session binding request failure corresponds to a session for a wireless user device. The method further comprises indicating, by the policy controller, a retry timer to a session controller associated with the session for the wireless user device. The method further comprises providing, by the policy controller, network policies to the session controller for the session of the wireless user device. The method further comprises receiving, by the policy controller, a policy update request from the session controller in response to expiration of the retry timer. The method further comprises transferring, by the policy controller, a session binding request to the binding data store wherein the session binding request instructs the binding data store to store a session binding that associates the policy controller and the wireless user device.

Some embodiments comprise a wireless communication network. The wireless communication network comprises a policy controller, a session controller, and a binding data store. The policy controller detects a session binding request failure to a binding data store, wherein the session binding request failure corresponds to a session for a wireless user device. The policy controller indicates a retry timer to the session controller that manages the session for the wireless user device. The policy controller provides network policies to the session controller for the session of the wireless user device. The policy controller receives a policy update request from the session controller in response to expiration of the retry timer. The policy controller transfers a session binding request to the binding data store. The binding data store receives the session binding request. The binding data store stores a session binding that associates the policy controller and the wireless user device.

Some embodiments comprise one of more non-transitory computer readable storage media having program instructions stored thereon. When executed by a computing system, the program instructions direct the computing system to perform operations. The operations comprise detecting a session binding request failure to a binding data store in a wireless communication network, wherein the session binding request failure corresponds to a session for a wireless user device. The further operations comprise indicating a retry timer to a session controller associated with the session of the wireless user device. The further operations comprise providing a network policy to the session controller for the session of the wireless user device. The further operations comprise receiving a policy update request from the session controller in response to expiration of the retry timer. The further operations comprise transferring an instruction to the binding data store to create a session binding that associates a policy controller and the wireless user device.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates an exemplary operation of the communication network.

FIG. 3 illustrates another exemplary operation of the communication network.

FIG. 4 illustrates a Fifth Generation (5G) communication network.

FIG. 5 illustrates network functions in the 5G communication network.

FIG. 6 illustrates a Network Function Virtualization Infrastructure (NFVI) in the 5G communication network.

FIG. 7 further illustrates the NFVI in the 5G communication network.

FIG. 8 illustrates an exemplary operation of the 5G communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

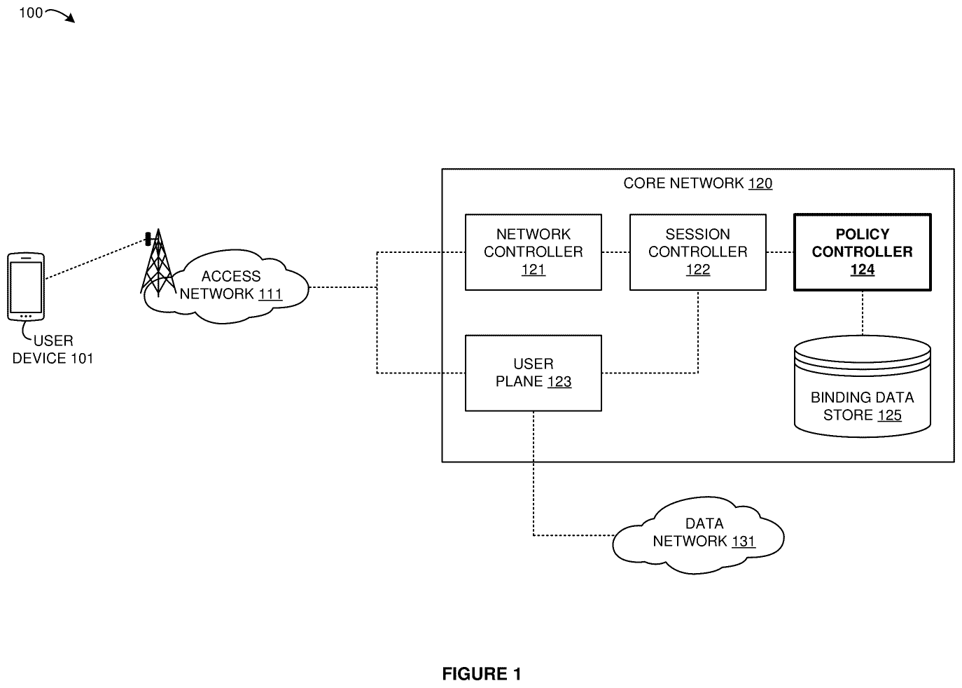

FIG. 1 illustrates communication network 100 to control session binding retry in response to session binding failure. Communication network 100 provides services like media-streaming, internet-access, voice/video calling, text messaging, machine communications, or some other wireless communications product. Communication network 100 comprises user device 101, access network 111, core network 120, and data network 131. Core network 120 comprises network controller 121, session controller 122, user plane 123, policy controller 124, and binding data store 125. In other examples, communication network 100 may comprise additional or different elements than those illustrated in FIG. 1.

Various examples of network operation and configuration are described herein. In some examples, user device 101 attaches to access network 111. Device 101 transfers a request for wireless network service to network controller 121 over access network 111. Network controller 121 approves the service request and interacts with session controller 122 to set up the requested session for device 101. Exemplary session types include data sessions, voice/video conferencing sessions, Internet Protocol (IP) messaging sessions (e.g., Rich Communication Service (RCS) messaging), and the like. Session controller 122 requests network policies for device 101 from policy controller 124. The network policies govern device 101′s behavior on network 100. Exemplary policies include data routing policies, network resource allocation policies, and Quality-of-Service (QoS). Policy controller 124 returns the requested policies to session controller 122. Session controller 122 controls user plane 123 to setup the session for user device 101 based on the policies retrieved from policy controller 124. Session controller 122 notifies network controller 121 which in turn directs device 101 to begin the session. Device 101 exchanges user data with user plane 123 over access network 111. User plane 123 exchanges user data with data network 131.

Policy controller 124 transfers a session binding request to binding data store 125. The request directs binding data store 125 to create a session binding between policy controller 124 and user device 101. The session binding associates user device 101 with policy controller 124. However, an error occurs that prevents binding data store 125 from creating the session binding between policy controller 124 and user device 101. Exemplary errors include computing errors (e.g., caused by excessive signaling load, microprocessor load, memory percent occupancy, etc.) that inhibit policy controller 124 from transferring the request, inhibit binding data store 125 from processing the session binding request, and/or inhibit binding data store 125 from storing the session binding. Policy controller 124 detects the request failure and selects a retry timer for session controller 122. Policy controller 124 indicates the retry timer to session controller 124. Session controller 124 sets the retry timer selected by policy controller 124 and continues managing the session for user device 101. Session controller 122 detects the expiration of the timer and transfers a policy update request to policy controller 124. In response, policy controller 124 transfers a session binding request to binding data store 125 to reattempt to create the session binding. At this point, the error condition is resolved and binding data store 125 successfully receives the request. Binding data store 125 stores a session binding that associates user device 101 and policy controller 124. Data store 125 notifies policy controller of the successful session binding. Policy controller 124 receives the notification from binding data store 125 and indicates the success to session controller 122.

Advantageously, wireless communication network 100 effectively and efficiently controls session binding creation retry in response to session binding failure. Moreover, wireless communication network increases the overall accuracy of the session binding maintained in binding data store 125 by inhibiting devices from continuing service on network 100 without creation of a session binding.

User device 101 comprises a vehicle, drone, robot, computer, phone, sensor, or another type of data appliance with wireless and/or wireline communication circuitry. User device 101 and access network 111 communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WIFI), Low-Power Wide Area Network (LP-WAN), Bluetooth, IEEE 802.3 (Ethernet), and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 111 is illustrated as a tower, network 111 may comprise another type of mounting structure (e.g., a building), or no mounting structure at all. Access network 111 comprises a Sixth Generation (6G) Radio Access Network (RAN), Fifth Generation (5G) RAN, LTE RAN, gNodeB, eNodeB, NB-IoT access node, trusted non-3GPP access node, untrusted non-3GPP access node, LP-WAN base station, wireless relay, WIFI hotspot, Bluetooth access node, and/or another wireless or wireline network transceiver. Access network 111 is connected to network core 120 over backhaul data links. Access network 111 exchanges network signaling and user data with network controller 121 and user plane 123 clustered together into core network 120. Access network 111 and core network 120 may communicate via edge networks like internet backbone providers, edge computing systems, or another type of edge system to provide the backhaul data and signaling links between access network 111 and core network 120.

Access network 111 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUS handle higher wireless network layers like the Radio Resource Control (RRC), Service Data Adaption Protocol (SDAP), and Packet Data Convergence Protocol (PDCP). The CUs are coupled to the network functions in core network 120. Access network 111 may also comprise RUs and Baseband Units (BBUs). The BBUs comprise network computers. The BBUs handle lower and higher network layers like RRC, PDCP, RLC, MAC, and PHY. The BBUs are coupled to network entities in core 120.

Core network 120 is representative of computing systems that provide wireless data services to user device 101 over access network 111. Exemplary computing systems comprise Network Function Virtualization Infrastructure (NFVI) systems, container-based virtualized computing systems, data centers, server farms, cloud computing networks, hybrid cloud networks, and the like. Core network 120 may comprise a Third Generation Partnership Project (3GPP) core network architecture like Sixth Generation Core (6GC), Fifth Generation Core (5GC), Evolved Packet Core (EPC), and/or another type of 3GPP core network architecture. Access network 111, core network 120, and data network 131 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WIFI, virtual switching, inter-processor communication, bus interfaces, and/or some other data communication protocols. The computing systems of core network 120 store and execute the network functions/entities to form network controller 121, session controller 122, user plane 123, policy controller 124, and binding data store 125.

Network controller 121 comprises network functions/entities like Access and Mobility Management Function (AMF) and Mobility Management Entity (MME). Session controller 122 comprises network functions/entities like Session Management Function (SMF). User plane 123 comprises network functions/entities like User Plane Function (UPF), Serving Gateway (S-GW), and Packet Gateway (P-GW). Policy controller 124 comprises network functions/entities like Policy Control Function (PCF), and Policy and Charging Rules Function (PCRF). Binding data store 125 comprises network functions/entities like Binding Support Function (BSF). Other data management functions/entities like Unified Data Management (UDM), Unified Data Registry (UDR), Home Subscriber Server (HSS), and Home Subscriber Registry (HLR) may be present in core 120. Data network 131 comprises an Application Server (AS) that hosts applications (e.g., media streaming applications, social network applications, online gaming applications, IP messaging applications, voice/video calling applications, etc.) for device 101.

User device 101 and access network 111 comprise antennas, amplifiers, filters, modulation, analog/digital interfaces, microprocessors, software, memories, transceivers, bus circuitry, and the like. User device 101, access network 111, core network 120, and data network 131 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSDs), Hard Disk Drives (HDDs), Non-Volatile Memory Express (NVMe) SSDs, and/or the like. The memories store software like operating systems, user applications, radio applications, network functions, and network entities. The microprocessors retrieve the software from the memories and execute the software to drive the operation of wireless communication network 100 as described herein.

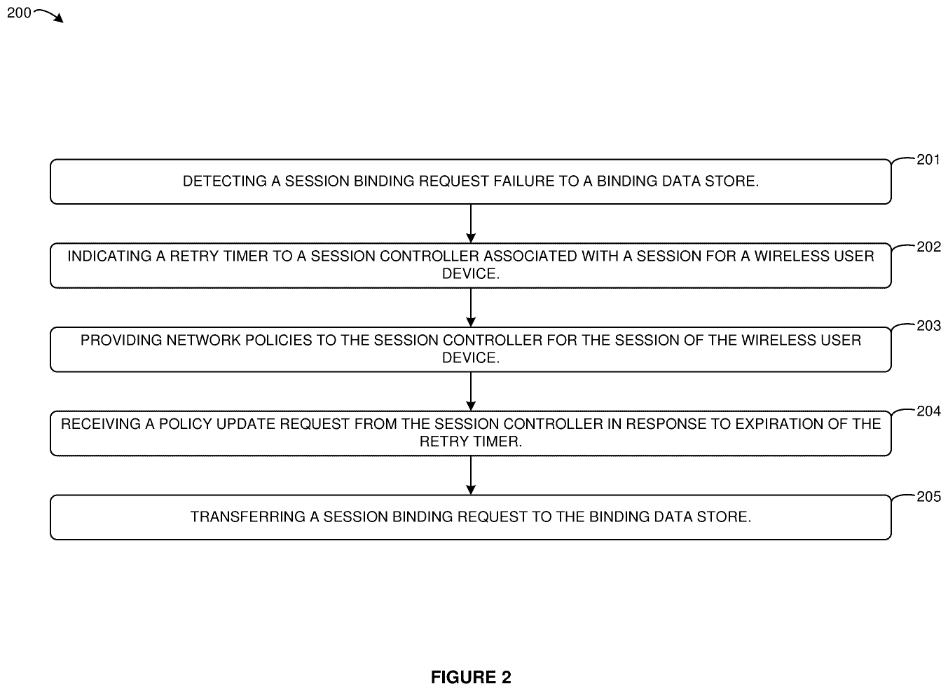

FIG. 2 illustrates process 200. Process 200 comprises an exemplary operation of communication network 100 to control session binding retry in response to session binding failure. The operation may vary in other examples. The operations of process 200 comprise detecting a session binding request failure to a binding data store (step 201). The session binding request failure corresponds to a session for a wireless user device. The operations further comprise indicating a retry timer to a session controller associated with the session for the wireless user device (step 202). The operations further comprise providing network policies to the session controller for the session of the wireless user device (step 203). The operations further comprise receiving a policy update request from the session controller in response to expiration of the retry timer (step 204). The operations further comprise transferring a session binding request to the binding data store (step 205). The binding data store receives the session binding request and stores a session binding that associates the policy controller and the wireless user device.

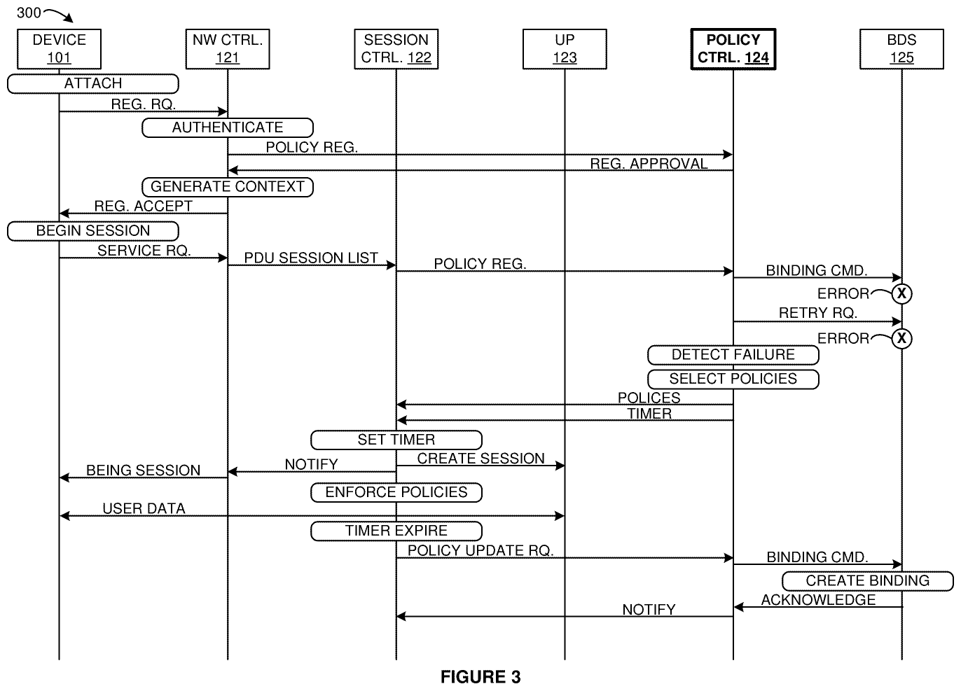

FIG. 3 illustrates process 300. Process 300 comprises an exemplary operation of wireless communication network 100 to control session binding retry in response to session binding failure. Process 300 comprises an example of process 200 illustrated in FIG. 2, however process 200 may differ. The operation may vary in other examples. In some examples, device 101 attaches to access network 101. Device 101 and access network 111 implement a Random Access Channel (RACH) process to establish a signaling link for device 101. Once the signaling link is established, device 101 transfers a registration request (REG. RQ.) to network controller 121 over access network 111. The registration request includes information like a registration type, 5G-Globally Unique Temporary Identifier (5G-GUTI), Tracking Area ID (TAI), Network Slice Selection Assistance Information (NSSAI) requests, UE capabilities, Protocol Data Unit (PDU) session requests, and the like.

Network controller (NW CTRL.) 121 authenticates the identity of device 101 and authorizes device 101 for service on network 100 based on the registration request. For example, network controller 121 may access a subscriber profile for device 101 managed by a UDM/HSS to authenticate and authorize device 101 for service on network 100. In response to authentication and authorization, network controller 121 registers device 101 with network core 120 and selects session controller 122 to serve device 101. Network controller 121 generates context for device 101 that comprises the subscriber data, network policies (e.g., Quality-of-Service (QoS) rules), network addresses (e.g., device IP address), and/or other information for device 101 to receive service on network 100. Network controller 121 transfers a registration (REG.) accept message to device 101. The registration accept message comprises the context.

Once registered, device 101 begins a session on network 100 based on the context. Device 101 transfers a service request to network controller 121 over access network 111. Network controller 121 selects session controller (CTRL.) 122 to serve device 101. Network controller 121 directs session controller 122 to establish the requested session for device 101. For example, device 101 may request media streaming Protocol Data Unit (PDU) session, media broadcasting PDU session, internet access PDU session, or some other session type and network controller 121 may direct session controller 122 to create the PDU session for device 101. Session controller 121 transfers a policy registration request to policy controller 124 to create a policy association for device 101. The request identifies device 101 with a user Identifier (ID) like Subscriber Permanent Identifier (SUPI), a Generic Public Subscription Identifier (GPSI), Internet Protocol (IP) address, and the like. Policy controller 124 directs binding data store (BDS) 125 to create a session binding between policy controller 124 and device 101. However, an error occurs on binding data store 125 that inhibits binding store 125 from creating a session binding. Exemplary errors comprise request timeouts and internal computing errors on policy controller 124 and binding data store 125. These errors may result from conditions like excessive signaling load, high microprocessor loading, high memory percent utilization, and the like. Policy controller 124 detects the error and transfers a retry request(s) to binding data store 125 to create the session binding. The error continues on controller 124 and/or store 125 and the retry request(s) do not succeed in creating the policy binding.

In response to the failed requests, policy controller 124 postpones session binding creation. Policy controller 124 selects one or more network policies for device 101's PDU session. Policy controller 124 stores session data characterizing the selected one or more policies. Exemplary policy types include Quality-of-Service (QoS) policies, resource allocations, data routing policies, and the like. Policy controller 124 selects a reverification timer for session controller 122 to retry to establish the session binding between controller 124 and device 101. For example, controller 124 may select a 30-minute reverification timer. Policy controller 124 returns the one or more selected policies to session controller 122 and indicates the reverification timer to session controller 122.

Session controller 122 receives the network policies from policy controller 124. Session controller 122 sets the revalidation timer. Session controller 122 directs user plane (UP) 123 to set up the data links to support the session. When the network data links to support the session are organized, session controller 122 notifies network controller 121. Network controller 121 directs device 101 to begin the session. Device 101 exchanges user data for the session with user plane 123 over access network 111. User plane 123 exchanges the user data with data network 131. Session controller 122 controls user plane 123 to enforce the policies retrieved from policy controller 124.

At this point, the PDU session for device 101 is established and a policy association for device 101 has been created, however a session binding between device 101 and policy controller 124 has not yet been created. As session controller 122 manages the session for device 101, the revalidation timer expires. Session controller 122 detects the expiration of the timer which triggers a policy update condition on controller 122. Session controller 122 transfers a policy update request to policy controller 124. The update request identifies device 101 by a user ID (e.g., SUPI, GPSI, IP address, etc.). In response to the update request, policy controller 124 transfers a binding command (CMD.) to binding data store 125. The command comprises an instruction that directs binding data store 125 to store a session binding that associates policy controller 124 and device 101. The time period set by the revalidation timer allows the error condition on policy controller 124 and/or binding data store 125 (e.g., by a fall in signaling load). Binding data store 125 successfully receives the command and stores the network address of policy controller 124 in association with the user ID of device 101 to create the session binding. Binding data store 125 notifies policy controller 124 that the binding session data is created. Policy controller 124 notifies session controller 122 of the successful session binding creation.

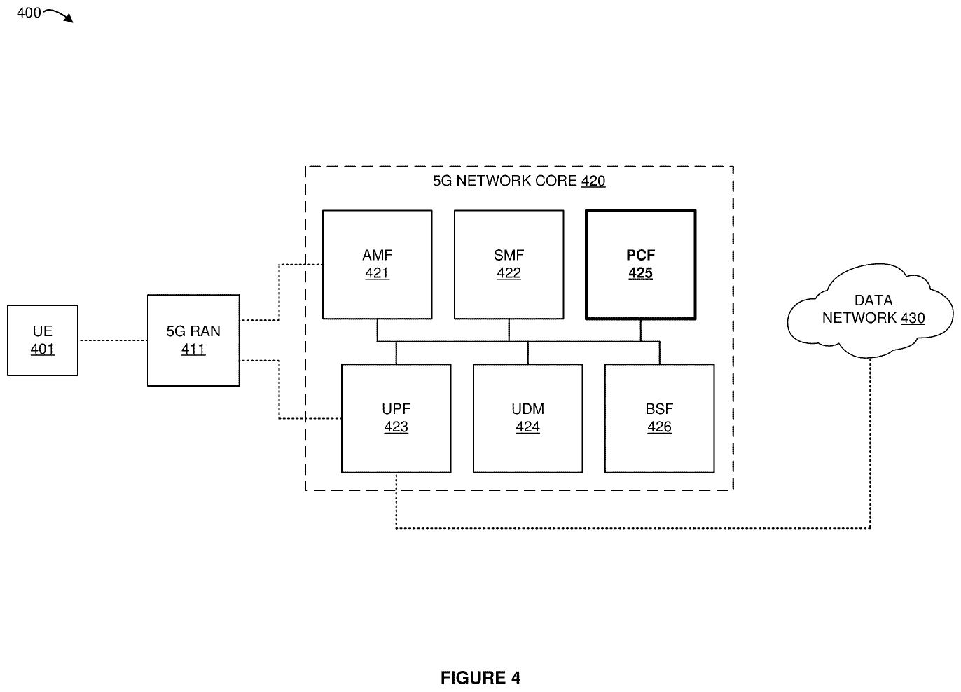

FIG. 4 illustrates 5G communication network 400 to control session binding retry in response to session binding failure. 5G communication network 400 comprises an example of communication network 100 illustrated in FIG. 1, however network 100 may differ. 5G communication network 400 comprises 5G UE 401, 5G RAN 411, 5G network core 420, and data network 430. 5G network core 420 comprises AMF 421, SMF 422, UPF 423, UDM 424, PCF 425, and BSF 426. Other network functions and network entities like Authenticating Server Function (AUSF), Network Slice Selection Function (NSSF), Unified Data Registry (UDR), Network Repository Function (NRF), Charging Function (CHF), Short Message Service Function (SMSF), Network Exposure Function (NEF), Application Function (AF), Equipment Identity Register (EIR), and Session Communication Proxy (SCP) are typically present in 5G network core 420 but are omitted for clarity. In other examples, 5G communication network 400 may comprise different or additional elements than those illustrated in FIG. 4.

In some examples, UE 401 wirelessly attaches to 5G RAN 411 over a 5GNR link. UE 401 undergoes a RACH procedure with 5G RAN 411 to establish a secure signaling channel. UE 401 transfers a registration request to AMF 421 over 5G RAN 411. The registration request indicates a registration type, 5G-GUTI, TAI, NSSAI requests, UE capabilities, and the like. The initial registration request may additionally include PDU session requests. In response to the registration request, AMF 421 transfers a Non-Access Stratum (NAS) identity request to UE 401 over a NAS signaling link between UE 401 and AMF 421 that traverses RAN 411. UE 401 indicates its Subscriber Concealed Identifier (SUCI) to AMF 421 over the NAS link that traverses 5G RAN 411. AMF 421 indicates the SUCI of UE 401 to UDM 424, typically over an AUSF, to retrieve authentication vectors to authenticate UE 401. UDM 424 returns the SUPI for UE 401 and authentication vectors like an expected result, random number, key selection criteria, and the like. AMF 421 transfers an authentication challenge that comprises the random number and key selection criteria to UE 401 over the NAS link that traverses RAN 411. UE 401 hashes random number with its secret key to generate an authentication result and indicates the authentication result to AMF 421 over the NAS link. AMF 421 matches the expected result retrieved from UDM 424 with the authentication result received from UE 401 to authenticate UE 401.

Responsive to the authentication, AMF 421 transfers a context registration request to UDM 424 that includes AMF ID, a supported feature list, a Permanent Equipment Identifier (PEI) for UE 401, and the like. UDM 424 indicates successful UDM registration to AMF 421. In response, AMF 421 requests access and mobility subscription data, SMF selection subscription data, and UE context in SMF data from UDM 424. UDM 424 accesses the subscriber profile for UE 401 stored by a UDR (not illustrated) and returns the requested data. The access and mobility subscription data comprises a supported feature list for UE 401 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of S-NSSAIs and associated information. The UE context in SMF data comprises PDU session and EPC interworking information.

AMF 421 transfers a policy creation request to PCF 425 to create a policy association for UE 401. PCF 425 responds to the request with policy association information like the SUPI, GPSI, PEI, and user location information for UE 401. PCF 425 subscribes to AMF 421 for event reporting like user location updates, registration state changes, communication failure events, and the like. AMF 421 creates a PCF subscription based on the policy association information and signals to PCF 425 of the successful subscription creation. AMF 421 may also interact with an NSSF to select one or more network slices for UE 401 based on the slice selection information.

Responsive to policy association creation, AMF 421 registers UE 401 for service on network 400. AMF 421 generates UE context for UE 401 that comprises the subscriber data retrieved from UDM 424, network policies retrieved from PCF 425, and/or other data to enable service for UE 401 on network 400. The UE context defines the authorized services and network policies for UE 401. AMF 421 generates a registration accept message that includes the UE context. AMF 421 transfers the registration accept message to UE 401 over RAN 411.

UE 401 receives a user input and responsively launches a user application. UE 401 wirelessly transfers service request to AMF 421 over RAN 411 to create a PDU session for the application. The service request includes a PDU session list. AMF 421 selects SMF 422 to serve UE 401 based on SMF selection data received from UDM 424 and network policies received from PCF 425. AMF 421 transfers a PDU session update request to SMF 422 that includes the PDU session list received from UE 401 and PDU session activation command. In response to the request, SMF 422 transfers a policy creation request to PCF 425 to create a policy association for UE 401. The request indicates the SUPI for UE 401.

PCF 425 receives the request and creates a policy association for UE 401. PCF 425 indicates the creation to SMF 422. PCF 425 transfers a binding information post request to BSF 426. The post request indicates the network address PCF 425 and SUPI for UE 401 (and potentially other subscriber IDs like GUTI and IP address). BSF 426 comprises capabilities to store session bindings that associate UEs and PCFs in network 400. The session bindings store the SUPI/GUTI/IP address for a UE with a network address for a PCF. Typically, BSF 426 receives the post request from PCF 425 and stores a session binding that associates PCF 425 with UE 401. However, an error occurs on BSF 426 that temporarily prevents BSF 426 from receiving the post request and/or creating the session binding. For example, BSF 426 may be experiencing a threshold level of CPU loading (e.g., 85%), a threshold level of memory utilization (e.g., 85%), or excessive signaling which prevents BSF 426 from processing the post request. PCF 425 fails to receive an acknowledgement message from BSF 426. PCF 425 detects a session binding failure and transfers one or more retry requests to attempt to drive BSF 426 to create the session binding.

The retry requests are not successful which triggers PCF 425 to select a revalidation time (e.g., 30 minutes) for SMF 422 to reattempt to create the session binding between PCF 425 and UE 401. The revalidation time allows the error condition on BSF 426 to be resolved naturally (e.g., signaling load subsides) or by network operator action. PCF 425 creates a policy association for UE 401. PCF 425 transfers a policy creation request to SMF 422 that indicates the policy association creation, a revalidation command, and the revalidation time.

SMF 422 receives the response and sets a revalidation timer equal to the revalidation time. SMF 422 transfers a policy update request to PCF 425 to retrieve session management policies for UE 401 from PCF 425. PCF 425 receives the request and selects session management policies for UE 401 that include data routing rules, UPF selection rules, resource allocation rules, QoS parameters, and/or other session management policies. For example, PCF 425 may interact with a UDR to select session management policies based on the network attributes included in UE 401 subscriber profile stored by the UDR. PCF 425 generates and stores session data that characterizes the selected policies. PCF 425 transfers a policy update response that includes the session management policies to SMF 422.

SMF 422 receives the session management policies from PCF 425. SMF 422 allocates a UE IP address for the requested PDU session, a Tunnel End Point ID (TEID) for the session, and selects UPF 423 to support the PDU session. Upon selection of UPF 423, SMF 422 transfers a session modification request that includes a session endpoint identifier and TEID to UPF 423 to setup the default bearer for UE 401. The default bearer is a data link to carry data and data (e.g., voice/video conferencing data, IP messaging data, internet traffic, etc.) between UE 401 and data network 430. The default bearer traverses 5G RAN 411 and UPF 423. Upon reception of the request, UPF 423 may receive and buffer downlink data for the PDU sessions of UE 401. UPF 423 transfers a session modification response to SMF 423 indicating the default bearer is ready begin the session. SMF 422 transfers a PDU session update response to AMF 421 to notify AMF 421 that the UE 401's PDU session is ready to begin.

AMF 421 receives the PDU session update response from SMF 422. AMF 421 indicates the UE IP address and TEID for the session to UE 401 over RAN 411 and directs UE 401 to begin the PDU session. UE 401 begins the session based on the UE context, UE IP address, and TEID. UE 401 exchanges user data for the PDU session with UPF 423 over the default bearer the traverses RAN 411. UPF 423 exchanges the user data with data network 430. SMF 422 controls UPF 423 to enforce the session management network policies received from PCF 425.

At this point, SMF 422 is managing an active PDU session(s) for UE 401, but a session binding has not been created between UE 401 and PCF 424. The revalidation timer expires which triggers a policy update condition in SMF 422. SMF 422 transfers a policy update request to PCF 425 that comprises the SUPI for UE 401 and that directs PCF 425 to create the session binding between UE 401 and PCF 425. In response, PCF 425 transfers a binding information post request to BSF 426. The post request indicates the network address PCF 425 and SUPI (and potentially other identifiers) for UE 401. During the period of the revalidation timer, the error condition on BSF 426 resolves. BSF 426 successfully receives the post request and stores a session binding that associates the network address of PCF 425 and the SUPI of UE 401. BSF 426 transfers a binding information post response to PCF 425 indicating the successful session binding. PCF 425 transfers a policy update response to SMF 422 indicating the successful session binding.

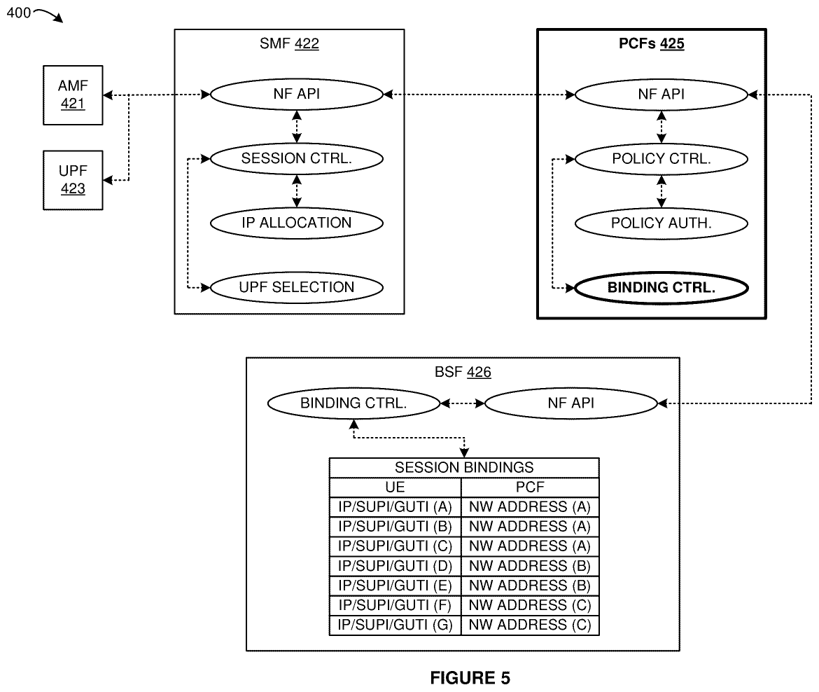

FIG. 5 illustrates SMF 422, PCF 425, and BSF 426 in 5G communication network 400. In some examples, SMF 422 comprises modules for network function (NF) Application Programming Interface (API), session control, IP address allocation, and UPF selection. The session control module establishes PDU sessions over UPF 423, controls UPF 423 to enforce session management policies retrieved from PCF 425, and monitors data volume to generate usage reports for the PDU sessions. The IP allocation module allocates IP addresses and TEIDs for PDU sessions. The UPF selection module selects UPFs (e.g., UPF 423) for PDU sessions based on UPF selection data retrieved from UDM 424 and/or PCF 425.

PCF 425 comprises modules for network function API, policy control, policy authorization, and binding data control. The policy control module creates policy associations for UEs on network 400, provides selected policies to other network functions (e.g., AMF 421, SMF 422, etc.) in core 420, and generates session data characterizing the selected policies for the PDU sessions. The policy authorization model authorizes policy requests (e.g., by interfacing with UDM 424) from SMF 422. The binding control module creates session bindings on BSF 426, detects session binding failures, and selects revalidation times for SMF 422 in response to session binding failure.

BSF 426 comprises modules for network function API and binding control and stores session binding data. The binding control module creates session bindings in response to session binding requests received from PCFs 425. The session binding data associates UEs by IP, SUPI, and/or GUTI with network addresses for PCFs and in network 400. The network functions APIs provide communication interfaces between SMF 422, PCF 425, BSF 426, and the other network functions in core 420 (e.g., AMF 421, UPF 423, etc.).

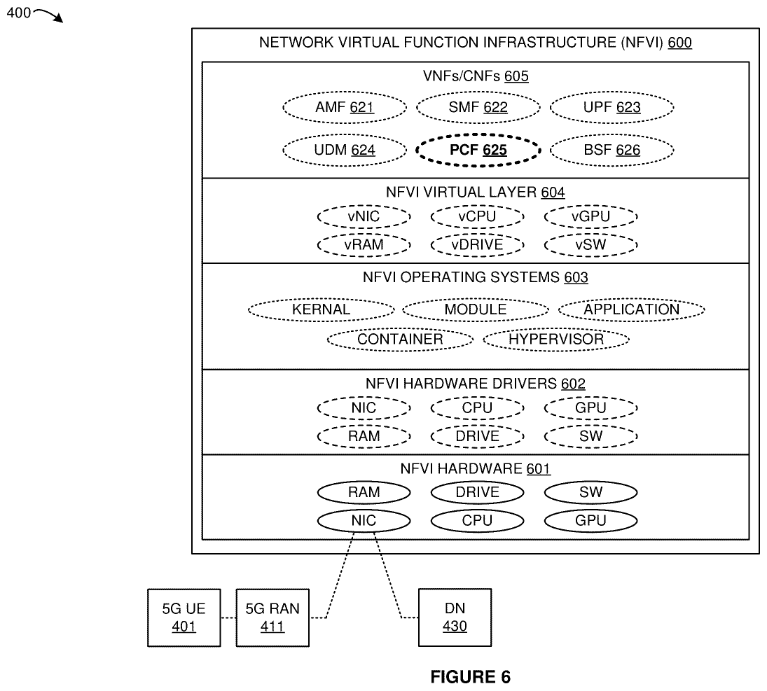

FIG. 6 illustrates Network Function Virtualization Infrastructure (NFVI) 600 in 5G wireless communication network 400. NFVI 600 comprises an example of core network 120 illustrated in FIG. 1, although core network 120 may differ. NFVI 600 comprises NFVI hardware 601, NFVI hardware drivers 602, NFVI operating systems 603, NFVI virtual layer 604, and NFVI Virtual Network Functions (VNFs)/Cloud-Native Network Functions (CNFs) 605. NFVI hardware 601 comprises Network Interface Cards (NICs), CPU, GPU, RAM, Flash/Disk Drives (DRIVE), and Data Switches (SW). NFVI hardware drivers 602 comprise software that is resident in the NIC, CPU, GPU, RAM, DRIVE, and SW. NFVI operating systems 603 comprise kernels, modules, applications, containers, hypervisors, and the like. NFVI virtual layer 604 comprises vNIC, vCPU, vGPU, vRAM, vDRIVE, and vSW. NFVI VNFs/CNFs 605 comprise AMF 621, SMF 622, UPF 623, UDM 624, PCF 625, and BSF 626. Additional VNFs and network elements like AUSF, NSSF, UDR, NRF, SMSF, CHF, NEF, AF, EIR, and SCP are typically present but are omitted for clarity. NFVI 600 may be located at a single site or be distributed across multiple geographic locations. The NIC in NFVI hardware 601 is coupled to 5G RAN 411 and data network (DN) 430. NFVI hardware 601 executes NFVI hardware drivers 602, NFVI operating systems 603, NFVI virtual layer 604, and NFVI VNFs/CNFs 605 to form AMF 421, SMF 422, UPF 423, UDM 424, PCFs 425, and BSF 426.

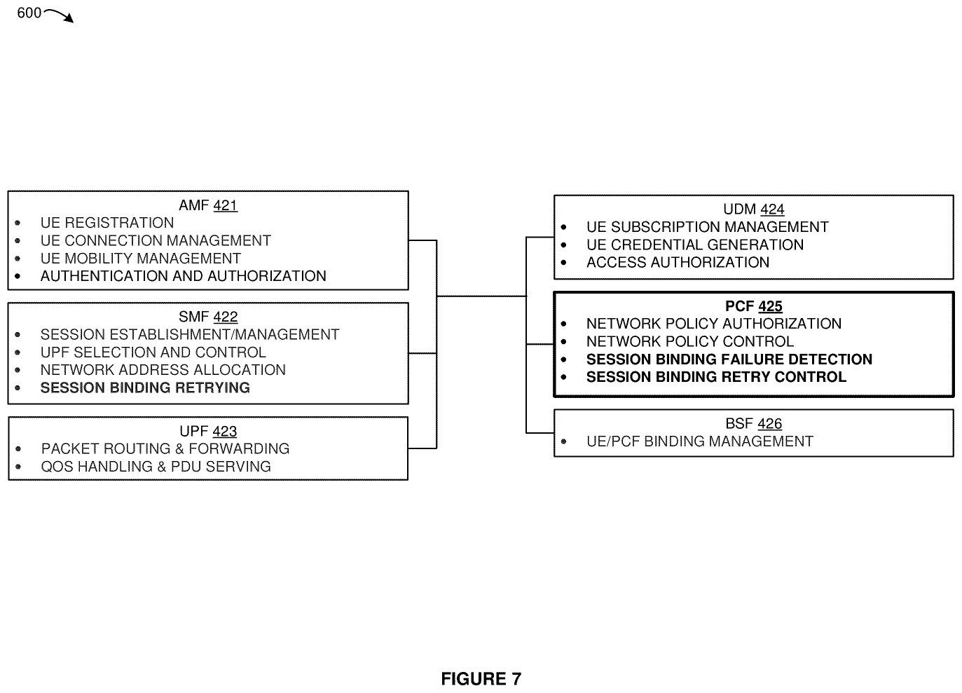

FIG. 7 further illustrates NFVI 600 in 5G communication network 400. AMF 421 comprises capabilities for UE registration, UE connection management, UE mobility management, authentication, and authorization. SMF 422 comprises capabilities for session establishment, session management, UPF selection, UPF control, network address allocation, and session binding retrying. UPF 423 comprises capabilities for packet routing, packet forwarding, QoS handling, and PDU serving. UDM 424 comprises capabilities for UE subscription management, UE credential generation, and UE access authorization. PCF 425 comprises capabilities for network policy authorization, network policy control, session binding failure detection, and session binding retry control. BSF 426 comprises capabilities for UE/PCF binding data management.

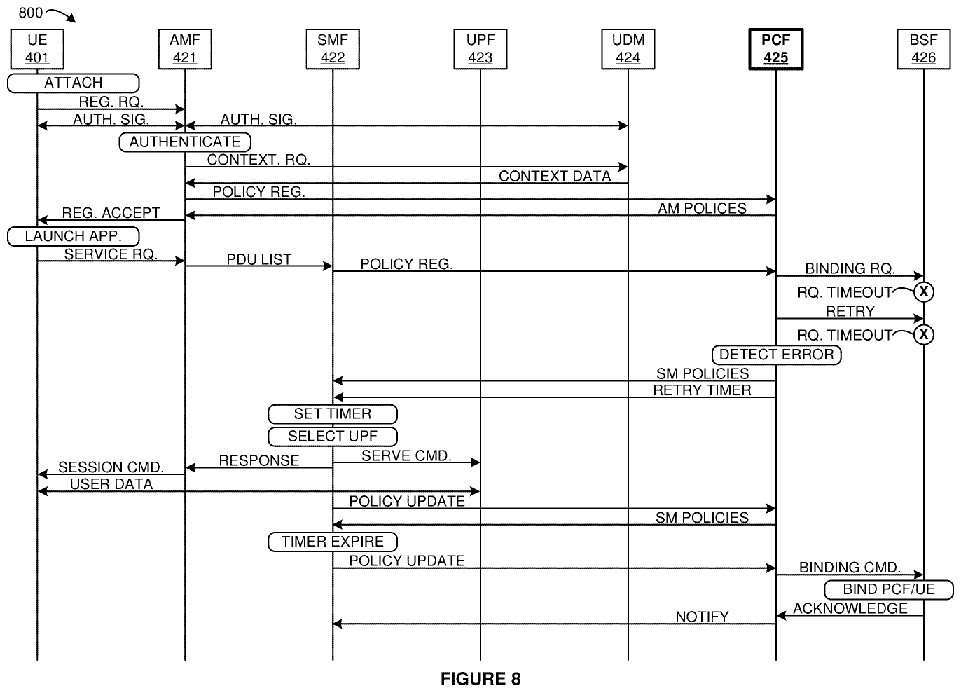

FIG. 8 illustrates process 800. Process 800 comprises an exemplary operation of 5G communication network 400 to control session binding retry in response to session binding failure. Process 800 comprises an example of processes 200 and 300 illustrated in FIGS. 2 and 3, however processes 200 and 300 may differ. Process 800 may vary in other examples. In some examples, UE 401 wirelessly attaches to 5G RAN 411 over a 5GNR link. UE 401 transfers a registration request to AMF 421 over 5G RAN 411. UE 401, AMF 4221, and UDM 424 exchange authentication signaling to validate the identity of UE 401. Responsive to the authentication, AMF 421 transfers a context registration request to UDM 424. UDM 424 accesses the subscriber profile of UE 401 and returns context data to AMF 421. AMF 421 generates UE context using the received data and transfers a policy creation request to PCF 425 to create a policy association for UE 401. PCF 425 returns access and mobility policies to AMF 421. Responsive to policy association creation, AMF 421 registers UE 401 for service on network 400. AMF 421 generates UE context for UE 401 that comprises the subscriber data retrieved from UDM 424, and access and mobility policies retrieved from PCF 425. The UE context defines the authorized services and network policies for UE 401. AMF 421 generates a registration accept message that includes the UE context. AMF 421 transfers the registration accept message to UE 401 over RAN 411.

UE 401 launches a media streaming application (APP.) in response to a user input and wirelessly transfers a PDU session request to AMF 421 over RAN 411. AMF 421 selects SMF 422 to establish the media streaming PDU session for UE 401 based on SMF selection data received from UDM 424 during registration. AMF 421 transfers a PDU session update request to SMF 422 that identifies the media streaming PDU session and includes a PDU session activation command. In response to the request, SMF 422 transfers a policy create request UE 401's SUPI to PCF 425 to create a policy association for UE 401.

PCF 425 creates a policy association for UE 401. PCF 425 indicates the creation to SMF 422. PCF 425 transfers a session binding request to BSF 426 that includes UE 401's SUPI. However, BSF 426 experiences excessive signaling and the request times-out. PCF 425 detects the timeout and transfers a retry request to BSF 426 to attempt to complete the transaction. The retry request times-out as well and PCF 425 detects an error on BSF 426. PCF 425 selects a revalidation time for SMF 422 to reattempt policy binding. PCF 425 selects session management policies for UE 401 and stores session data that characterizes the selected policies. PCF 425 transfers a policy update response that includes the session management policies to SMF 422 and the revalidation time to SMF 422.

SMF 422 receives the response and sets a revalidation timer equal to the time specified by PCF 425. SMF 422 allocates network addresses for the PDU session and selects UPF 423 to support the PDU session. SMF 422 transfers a session modification request that includes a session endpoint identifier and TEID to UPF 423. UPF 423 establishes a default bearer for the session. UPF 423 transfers a session modification response to SMF 423 indicating the default bearer is ready begin the session.

AMF 421 indicates the network addresses for the session to UE 401 and directs UE 401 to begin the PDU session. UE 401 begins the session based on the UE context and network addresses. UE 401 exchanges user data for the media streaming PDU session with UPF 423 over the default bearer the traverses RAN 411. UPF 423 exchanges the user data for the media streaming session with data network 430. SMF 422 controls UPF 423 to enforce the network policies and rules received from PCF 425.

The revalidation timer expires and SMF 422 transfers a policy update request to PCF 425 to create the session binding between UE 401 and PCF 425. PCF 425 transfers a binding information post request to BSF 426. The post request indicates the network address PCF 425 and SUPI (and potentially other identifiers) for UE 401. During the period of the revalidation timer, the error condition on BSF 426 resolves. BSF 426 successfully fields the post request and stores a session binding that associates the network address of PCF 425 and the SUPI of UE 401. BSF 426 indicates the successful session binding to PCF 425. PCF 425 notifies SMF 422 of the successful session binding.

The wireless data network circuitry described above comprises computer hardware and software that form special-purpose network circuitry to control session binding retry in response to session binding failure. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to control session binding retry in response to session binding failure.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
detecting, by a policy controller of a wireless communication network, a session binding request failure to a binding data store, wherein the session binding request failure corresponds to a session for a wireless user device;
indicating, by the policy controller, a retry timer to a session controller associated with a session for a wireless user device;
providing, by the policy controller, network policies to the session controller for the session of the wireless user device;
receiving, by the policy controller, a policy update request from the session controller in response to expiration of the retry timer; and
transferring, by the policy controller, a session binding request to the binding data store wherein the session binding request instructs the binding data store to store a session binding that associates the policy controller and the wireless user device.

2. The method of claim 1 further comprising:
receiving, by the policy controller, a policy creation request from the session controller; and
transferring, by the policy controller, an initial session binding request to the binding data store.

3. The method of claim 2 wherein detecting, by the policy controller, the session binding request failure comprises detecting the session binding request failure in response to transferring the initial session binding request to the binding data store.

4. The method of claim 1 wherein the session binding request failure comprises one or more of a request timeout, a computing error in the policy controller, or a computing error in the binding data store.

5. The method of claim 1 wherein:
the session binding associates a network address for the policy controller with a user Identifier (ID) for the wireless user device; and
the user ID comprises one or more of a Subscriber Permanent Identifier (SUPI), a Generic Public Subscription Identifier (GPSI), and an Internet Protocol (IP) address for the wireless user device.

6. The method of claim 1 wherein:
the network policies for the wireless user device comprise session management policies; and
the session management policies comprise one or more of a Quality-of-Service (QoS) policy, a data routing policy, or a resource allocation policy.

7. The method of claim 1 further comprising:
executing, by Network Function Virtualized Infrastructure (NFVI) of the wireless communication network, the policy controller, session controller, and binding data store; and wherein:
the policy controller comprises a Fifth Generation Core (5GC) Policy Control Function (PCF);
the session controller comprises a 5GC Session Management Function (SMF); and
the binding data store comprises a 5GC Binding Support Function (BSF).

8. A wireless communication network comprising:
a policy controller, a session controller, and a binding data store;
the policy controller configured to:
detect a session binding request failure to a binding data store, wherein the session binding request failure corresponds to a session for a wireless user device;
indicate a retry timer to the session controller that manages the session for the wireless user device;
provide network policies to the session controller for the session of the wireless user device;
receive a policy update request from the session controller in response to expiration of the retry timer; and
transfer a session binding request to the binding data store;
the binding data store configured to:
receive the session binding request; and
store a session binding that associates the policy controller and the wireless user device.

9. The wireless communication network of claim 8 wherein the policy controller is further configured to:
receive a policy creation request from the session controller; and
transfer an initial session binding request to the binding data store.

10. The wireless communication network of claim 9 wherein the policy controller is configured to detect the session binding request failure in response to transferring the initial session binding request to the binding data store.

11. The wireless communication network of claim 8 wherein the session binding request failure comprises one or more of a request timeout, a computing error in the policy controller, or a computing error in the binding data store.

12. The wireless communication network of claim 8 wherein:
the session binding associates a network address for the policy controller with a user Identifier (ID) for the wireless user device; and
the user ID comprises one or more of a Subscriber Permanent Identifier (SUPI), a Generic Public Subscription Identifier (GPSI), and an Internet Protocol (IP) address for the wireless user device.

13. The wireless communication network of claim 8 wherein:
the network policies for the wireless user device comprise session management policies; and
the session management policies comprise one or more of a Quality-of-Service (QoS) policy, a data routing policy, or a resource allocation policy.

14. The wireless communication network of claim 8 further comprising:
a Network Function Virtualization Infrastructure (NFVI); and wherein:
the NFVI includes the policy controller, the session controller, and the binding data store;
the policy controller comprises a Fifth Generation Core (5GC) Policy Control Function (PCF);
the session controller comprises a 5GC Session Management Function (SMF); and
the binding data store comprises a 5GC Binding Support Function (BSF).

15. One of more non-transitory computer readable storage media having program instructions stored thereon, wherein the program instruction, when executed by a computing system, direct the computing system to perform operations, the operations comprising:
detecting a session binding request failure to a binding data store in a wireless communication network, wherein the session binding request failure corresponds to a session for a wireless user device;
indicating a retry timer to a session controller associated with the session of the wireless user device;
providing a network policy to the session controller for the session of the wireless user device;
receiving a policy update request from the session controller in response to expiration of the retry timer; and
transferring an instruction to the binding data store to create a session binding that associates a policy controller and the wireless user device.

16. The computer readable storage media of claim 15 wherein the operations further comprise:
receiving a policy creation request from the session controller; and
transferring an initial session binding request to the binding data store.

17. The computer readable storage media of claim 16 wherein detecting the session binding request failure comprises detecting the session binding request failure in response to transferring the initial session binding request to the binding data store.

18. The computer readable storage media of claim 15 wherein the session binding request failure comprises one or more of a request timeout an internal server error.

19. The computer readable storage media of claim 15 wherein:
the session binding associates a network address for the policy controller with a user Identifier (ID) for the wireless user device;
the user ID comprises one or more of a Subscriber Permanent Identifier (SUPI), a Generic Public Subscription Identifier (GPSI), and an Internet Protocol (IP) address for the wireless user device;
the network policy for the wireless user device comprises a session management policy; and
the session management policies comprise one or more of a Quality-of-Service (QoS) policy, a data routing policy, or a resource allocation policy.

20. The computer readable storage media of claim 15 wherein:
the policy controller comprises a Fifth Generation Core (5GC) Policy Control Function (PCF);
the session controller comprises a 5GC Session Management Function (SMF); and
the binding data store comprises a 5GC Binding Support Function (BSF).
